(19) United States
(12) Patent Application Publication
(10) Pub. No.: US 2006/0080070 A1
(43) Pub. Date: Apr. 13, 2006

(54) Math matrix

(76) Inventor: Scott Flansburg, Scottsdale, AZ (US)

Correspondence Address: Wright Law Group, PLLC, Suite 2, 7201 West Oakland, Chandler, AZ, 85226, US

(21) Appl. No.: 10/964,789

(22) Filed: Oct. 13, 2004

(51) Int. Cl. G06F 17/10

(52) U.S. Cl. 703/2

(57) ABSTRACT

The math matrix of the present invention provides a 10 by 10 grid containing 100 cells with a different two-digit number contained in each cell of the grid. The numbers in the cells range from 00 to 99. In the most preferred embodiments of the present invention a separate and distinct color is associated with each of the single digits 0 through 9. The math matrix is useful for both teaching and learning mathematical concepts and numerical relationships. Additional embodiments of the invention provide for various games for other applications of the math matrix as well.

### TECHNICAL FIELD

The present invention relates generally to the field of mathematics and more particularly to a specialized number matrix adapted for teaching arithmetic.

### BACKGROUND OF THE INVENTION

The field of mathematics and math instruction is filled with various teaching devices and tools designed to assist students in the process of learning arithmetical concepts. The need to understand numbers and the concepts of numerical manipulation and problem solving associated with applied math are critical skills in today's complex and technologically oriented society. Accordingly the ability of a student to quickly and easily understand and internalize the concept of numbers and number theory is important.

While the need for learning and employing math skills is well recognized, the ability to learn and apply mathematical concepts is not intuitive for many math students. This is due, in part, to the inherent skills and ability of each student to learn but is also related in large part to the types of techniques and tools available for teaching mathematical and numerical relationships. Typically, rote memorization and practice drills are employed to teach students math concepts. For example, many students have spent hours upon hours in the less-than-thrilling activity of memorizing multiplication tables. Similarly, most students, at one time or another, have employed flash cards in an attempt to learn certain math concepts and relationships.

While the previously employed tools and techniques for the study of math are useful for certain students, there are other students that are not able to make effective use of these existing tools and techniques. For example, some students are “visual” learners or “conceptual” learners and, for these students, memorization is usually not an effective means of learning and understanding mathematical concepts and numerical relationships. Typically, these students are labeled as “under achievers” or “slow learners” or otherwise branded as suffering from “math anxiety.” For these students, their early failed attempts at mathematical proficiency are merely harbingers of future disappointment as they continue to use tools and techniques that are not in harmony with their particular learning style.

As can be seen by the discussion presented above, there is a need for additional and improved tools for teaching and explaining math concepts, particularly the relationship between numbers and the interplay of number combinations. Without the development of new and useful tools to enhance the study of math concepts beyond simple memorization, the ability to learn and understand certain math concepts and number relationships will continue to be suboptimal for many students of math.

### BRIEF SUMMARY OF THE INVENTION

The math matrix of the present invention provides a 10 by 10 grid containing 100 cells with a different two-digit number contained in each cell of the grid. The numbers in the cells range from 00 to 99. In the most preferred embodiments of the present invention a separate and distinct color is associated with each of the single digits 0 through 9. The math matrix is useful for both teaching and learning mathematical concepts and numerical relationships. Additional embodiments of the invention provide for various games for other applications of the math matrix as well.

### BRIEF DESCRIPTION OF THE DRAWINGS

The preferred embodiments of the present invention will hereinafter be described in conjunction with the appended drawings, wherein like designations denote like elements, and:

FIG. 1 is a math matrix in accordance with a preferred embodiment of the present invention;

FIG. 2 is a flow chart for a method of using the math matrix of FIG. 1 to perform mathematical calculations in accordance with a preferred embodiment of the present invention;

FIG. 3 is a flow chart for a method of subtracting numbers using the math matrix of FIG. 1 in accordance with a preferred embodiment of the present invention; and

FIG. 4 is a flow chart for a method of adding numbers using the math matrix of FIG. 1 in accordance with a preferred embodiment of the present invention;

FIG. 5 is computer-implemented system for displaying and manipulating the math matrix of FIG. 1 in accordance with a preferred embodiment of the present invention; and

FIG. 6 is a schematic representation of a memory for the computer-implemented system of FIG. 5.

### DETAILED DESCRIPTION

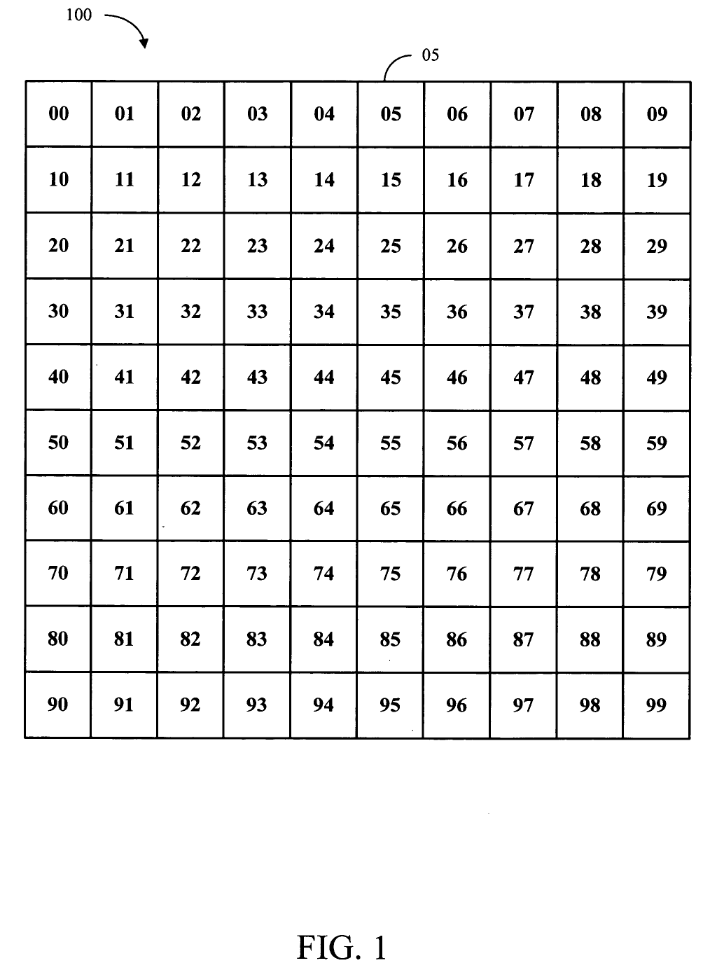

Referring now to FIG. 1, a math matrix 100 in accordance with a preferred embodiment of the present invention comprises a 10 by 10 grid (i.e., 10 rows and ten columns) containing 100 individual cells. Each cell contains a unique two-digit number, ranging in value from 00-99 (for the sake of convenience in discussing math matrix 100, each of the 100 cells shall be referenced by the same number as shown in the cell). In addition, the most preferred embodiments of the present invention have the two digit number arranged in the cells in a unique fashion, specifically adapted for the purpose of exploring various mathematical concepts and number relationships. As shown in FIG. 1, cells 00-09 (containing two-digit numbers 00-09 respectively) are arranged, from left to right, in ascending order in the first row of math matrix 100. Similarly, cells 10-19 (containing two-digit numbers 10-19 respectively) are arranged, from left to right, in ascending order in the second row of math matrix 100. The rest of the cells are arranged in a similar fashion, thereby constructing math matrix 100 substantially as shown in FIG. 1.

As seen in FIG. 1, the two-digit number 00 is placed into cell 00, located at the top left-most position in math matrix 100. Additionally, the two-digit number 99 is placed into cell 99, located in the lower right-most position in math matrix 100. The two-digit number 90 is placed into cell 90 that is located at the lower left-most position in math matrix 100 and the two-digit number 09 is placed into cell 09, located at the upper right-most position in math matrix 100.

Additionally, in the most preferred embodiments of the present invention, each single digit shares a color that is unique to all digits of the same mathematical value and not shared with any digits of a different mathematical value, regardless of which cell the digit is located in. For example, each digit with a value of “0” is colored black, each digit with a value of “1” is colored red, each digit with a value of “2” is colored light blue, each digit with a value of “3” is colored yellow, each digit with a value of “4” is colored light green, each digit with a value of “5” is colored orange, each digit with a value of “6” is colored purple, each digit with a value of “7” is colored pink, each digit with a value of “8” is colored dark blue and each digit with a value of “9” is colored dark green. Given this unique configuration of two-digit numbers, math matrix 100 is ready for use in exploring various mathematical concepts and numerical relationships.

At this juncture, several unique things about the relationship of the numbers contained in the cells of math matrix 100 can be observed. For example, all of the two-digit multiples of the number 9 can be found in the diagonally oriented series of cells starting with cell number 09, located in the upper-most right position of math matrix 100, and moving diagonally down and to the left through cells 18, 27, 36, 45, 54, 63, 72, 81, to cell 90, located in the lower left-most position in math matrix 100.

It should also be noted that each of the cells that comprise the external border of math matrix 100 contains either the digit 0 or the digit 9. Additionally, all cells containing two-digit numbers where both digits of the two-digit number are the same (i.e., 00, 11, 22, 33, etc.) can be found in the diagonally oriented series of cells starting with cell 00, located in the upper-most left position of math matrix 100, and moving diagonally down and to the right through cells 11, 22, 33, 44, 55, 66, 77, 88, to cell 99, located in the lower right-most position in math matrix 100.

When taking into account the colors associated with each of the digits, it should be noted that all of the cells containing any single digit having the same numerical value will form an intersection of a single row and single column within math matrix 100. For example, each of the cells that contain a digit with a numerical value of “4” in the second position of the two-digit number contained within that cell (i.e., cells 04, 14, 24, 34, 44, 54, 64, 74, 84, and 94) form a column that intersects with the row formed by the cells that contain a digit with a numerical value of “4” in the first position of the two-digit number contained within that cell (i.e., cells 40, 41, 42, 43, 44, 45, 46, 47, 48, and 49) at the location where both digits have a numerical value equal to “4” (i.e., cell 44). This same relationship exists for all other digits in the cells of math matrix 100.

Yet another interesting feature of the numerical digits contained in the cells of math matrix 100 is the ability of implementing a method for reducing the two-digit number contained in each and every cell of math matrix 100 to the number “9.” For example, selecting cell 89 of math matrix 100, the two individual digits “8” and “9” are added together to obtain the sum “17.” If the number “17” is then subtracted from the two-digit number “89” contained in cell 89, the number “72” is the result. Then, the digits “7” and “2” are added to achieve the final result of “9.” Similarly, selecting the number contained in cell 59 of math matrix 100, the addition of the digits “5” and “9” equals the number “14.” When the number “14” is subtracted from the number “59” contained in cell 59 equals the number “45.” When the digits of this number “4” and “5” are added together, the sum is “9.” The exact same methodology can be employed for each and every cell in math matrix 100.

Additionally, the addition of the single digits in each and every cell in math matrix 100 can provide other interesting patterns for observation. For example, starting in cell 70 of math matrix 100, the addition of the digits “7”+“0” equals the number “7.” Then, moving diagonally up and to the right to cell 61, which contains the digits “6” and “1,” which can also be added together to obtain the sum of “7.” Similar results can be obtained by adding all of the digits in the remaining cells that form the diagonal from cell 70 to cell 07. The same pattern can be observed for every grouping of cells that form a similar diagonal from the leftmost column to the corresponding cell in the uppermost row. For example, “8”+“0” equals “8,” “7”+“1” equals “8,” “6”+“2” equals “8,” etc.

The counterpart for the addition of digits can be observed by selecting a cell on the left-most column and moving diagonally down and to the right. For example, starting in cell 20, which contains the digits “2” and “0,” the equation “2”−“0” equals “2.” Similarly, moving diagonally down and to the right to cell 31, subtracting the digit “1” from “3” equals “2.” Continuing in a similar fashion, subtracting the digits contained in cell 42 yields “2” and so forth. The same pattern can be observed for each and every diagonal group of cells that starts with a cell in the leftmost column of math matrix 100 and moves diagonally down and to the right.

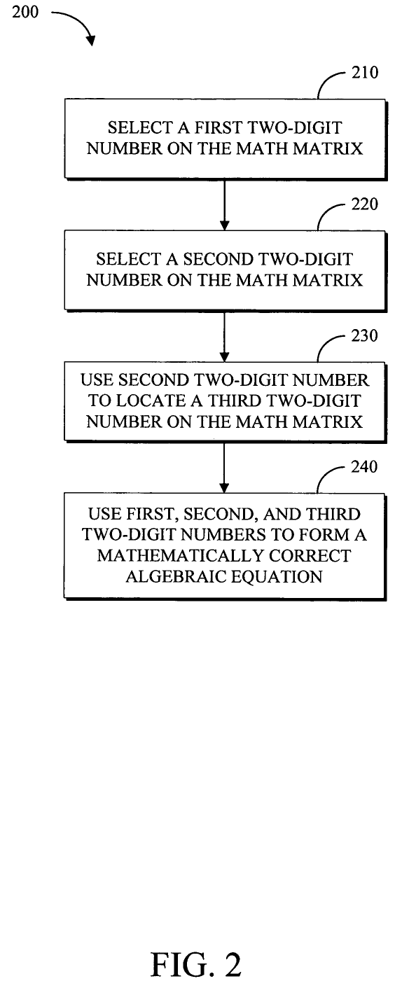

Referring now to FIG. 1 and FIG. 2, a method 200 for performing mathematical manipulation using two-digit numbers is depicted. To start, a first two-digit number on the math matrix is selected. Then, a second two-digit number on the math matrix is selected and used to calculate the location of a third two-digit number on math matrix 100, where the first two-digit number and the second two-digit number and the third two-digit number can be combined to form an arithmetically correct algebraic equation.

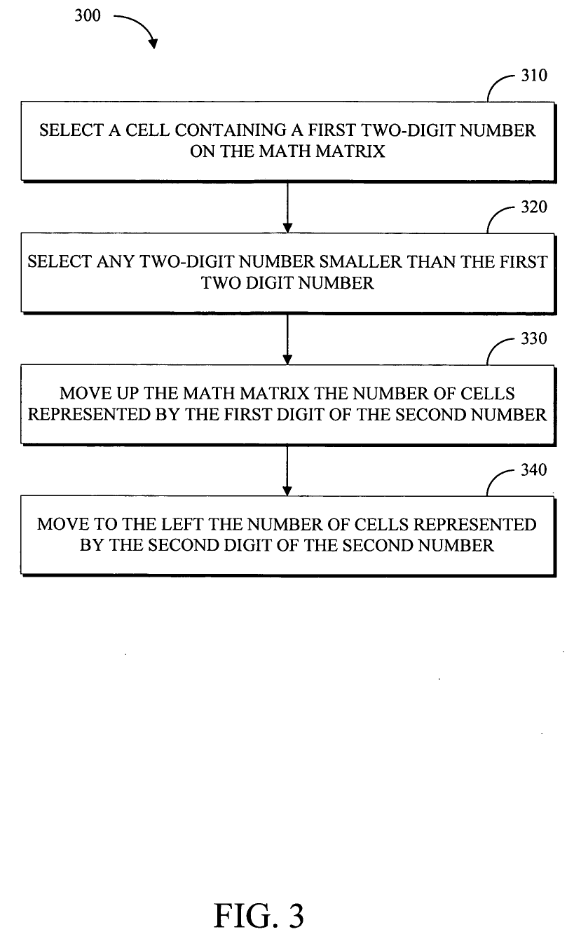

Referring now to FIG. 3, a method 300 for subtracting two digit numbers in accordance with a preferred embodiment of the present invention is depicted. As shown in FIG. 3, a first cell containing a first two-digit number is selected from the math matrix (step 310). Next, a second cell containing a second two-digit number is selected (step 320). In the most preferred embodiments of the present invention, the second number is numerically smaller or “less than” the first number. To perform the subtraction operation, the first selected cell is designated as the starting point. Then, a third cell on the math matrix can be identified by moving up the math matrix a number of cells equal to the first digit of the second two-digit number (step 330). This cell identifies an intermediate cell location. From the intermediate cell location, the third cell is identified by moving to the left a number of cells equal to the least significant digit of the previously-selected second two-digit number (step 340). The destination cell identifies the mathematically correct response for an equation subtracting the second two-digit number from the first two-digit number. It is important to note that step 330 and step 340 may be accomplished in reverse order and still achieve the same result.

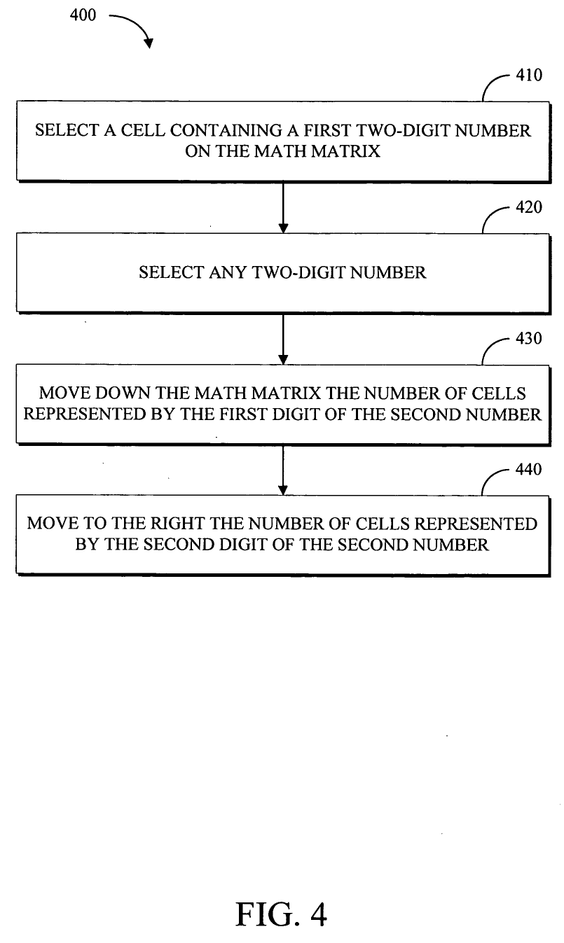

Referring now to FIG. 4, a method 400 for adding two digit numbers in accordance with a preferred embodiment of the present invention is depicted. As shown in FIG. 4, a first cell containing a first two-digit number is selected from the math matrix (step 410). Next, a second cell containing a second two-digit number is selected (step 420). To perform the addition operation, the first selected cell is designated as the starting point. Then, a third cell on the math matrix can be identified by moving down the math matrix a number of cells equal to the first digit of the second two-digit number (step 430). This cell identifies an intermediate cell location. From the intermediate cell location, the third cell is identified by moving to the right a number of cells equal to the least significant digit of the previously-selected second two-digit number (step 440). The destination cell identifies the mathematically correct response for an equation adding the second two-digit number from the first two-digit number. It is important to note that step 430 and step 440 may be accomplished in reverse order and still achieve the same result.

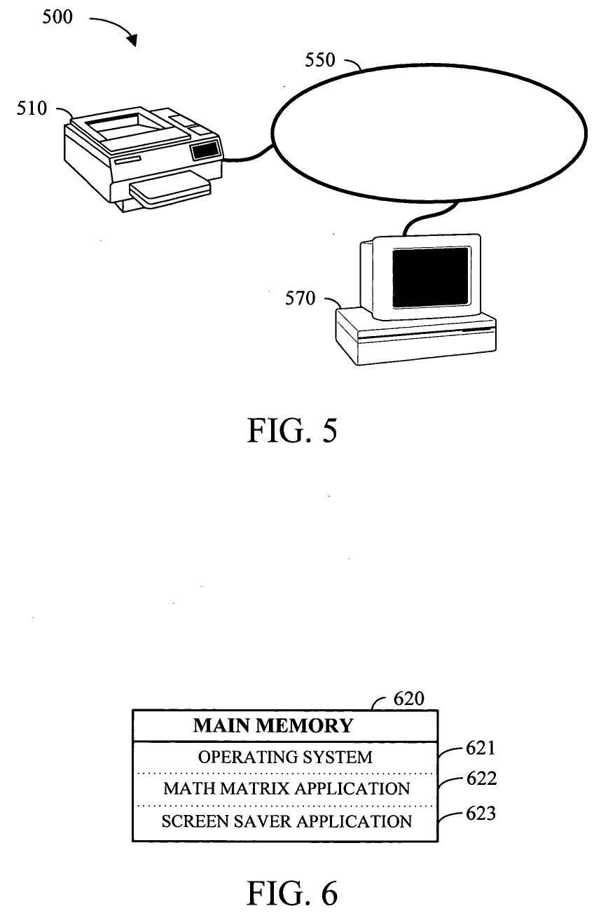

Referring now to FIG. 5, a computer-implemented system 500 for displaying and manipulating a math matrix in accordance with a preferred embodiment of the present invention is depicted. Computer-implemented system 500 includes a computer 570 connected or coupled via a network 550 to an optional printer 510.

Computer 170 may be any type of computer system known to those skilled in the art that is capable of being configured display and manipulate a math matrix as described herein. This includes laptop computers, desktop computers, tablet computers, pen-based computers and the like. Additionally, handheld and palmtop devices are also specifically included within the description of devices that may be deployed as computer 570. It should be noted that no specific operating system or hardware platform is excluded and it is anticipated that many different hardware and software platforms may be configured to create computer 570. Various hardware components and software components (not shown this FIG.) known to those skilled in the art may be used in conjunction with computer 570. Computer 170 will also include at least one main memory. The function of main memory is further described below in conjunction with FIG. 6.

Network 550 is any suitable computer communication link or communication mechanism, including a hardwired connection, an internal or external bus, a connection for telephone access via a modem or high-speed T1 line, infrared or other wireless communications, private or proprietary local area networks (LANs) and wide area networks (WANs), as well as standard computer network communications over the Internet or an internal network (e.g. “intranet”) via a wired or wireless connection, or any other suitable connection between computers and computer components known to those skilled in the art, whether currently known or developed in the future. It should be noted that portions of network 550 may suitably include a dial-up phone connection, broadcast cable transmission line, Digital Subscriber Line (DSL), ISDN line, or similar public utility-like access link including the Internet.

Optional printer 510 is a standard peripheral device that may be used to output paper versions of a math matrix in accordance with a preferred embodiment of the present invention. Additionally, various mathematical equations created from the two-digit numbers associated with the math matrix as well as reports, tests, etc. in conjunction with the manipulation of the math matrix and the number relationships processed by computer 570. Optional printer 510 may be directly connected to network 550 or indirectly connected via a connection to computer 570. Finally, it should be noted that optional printer 510 is merely representative of the many types of peripherals that may be utilized in conjunction with system 500. It is anticipated that other similar peripheral devices will be deployed in the various preferred embodiment of the present invention and no such device is excluded by its omission in FIG. 5.

Referring now to FIG. 6, main memory 620 suitable for use in conjunction with computer 570 of FIG. 5 is depicted. Main memory 620 preferably contains an operating system 621, a math matrix application 622, and/or a screen saver application 623. The term “memory” as used herein refers to any storage location in the virtual memory space of computer 570.

Operating system 621 includes the software that is used to operate and control computer 570 of FIG. 5. In general, a central processing unit or microprocessor contained within computer 570 typically executes operating system 621. Operating system 621 may be a single program or, alternatively, a collection of multiple programs that act in concert to perform the functions of an operating system. Any operating system known to those skilled in the art may be considered for inclusion with the various preferred embodiments of the present invention.

Math matrix application 622 is a computer software application that is capable of creating and manipulating a math matrix in accordance with the various preferred embodiments of the present invention described herein. All of the games, mathematical equations, and numerical relationships explained herein can be created and displayed by math matrix application 622. Once math matrix application 622 has constructed a math matrix in accordance with a preferred embodiment of the present invention in the main memory, a user of system 500 can interact with the math matrix via a user input device such as mouse or keyboard. This user interaction can take the form of learning games for practicing mathematical operations such as addition and subtraction, etc.

Screen saver 623 is representative of a computer software application that is capable of generating a screen saver display comprising a math matrix in accordance with the various preferred embodiments of the present invention described herein. The use of screen savers is well known to those skilled in the art and screen saver 623 may be implemented in any number of ways. Regardless of the specific implementation, screen saver 623 will typically appear on the video display of computer 570 of FIG. 5 as determined by a series of user-selectable variables. Once screen saver 623 is activated, at least a portion of a math matrix in accordance with the various preferred embodiments of the present invention is displayed on the video display of computer 570 of FIG. 5. This display may include a series of displays which highlight one or more of the mathematical operations described in conjunction with FIGS. 1-4.

In another preferred embodiment of the present invention, math matrix 100 of FIG. 1 is printed onto a flat surface to form the basis of a board game. In this embodiment, a pair of 10-sided dice may also be provided. Each 10-sided die has a single digit 0-9 displayed on each of the 10 sides. By rolling both dice, one or more two-digit numbers can be obtained. Since every roll of the dice will provide a two-digit number contained on math matrix 100 of FIG. 1, all of the adding and subtracting activities described above can be implemented using the board game. For example, a first two-digit number can be obtained by rolling the dice. Then, a second two-digit number can be obtained by rolling the dice again. With these two-digit numbers, various addition and/or subtraction equations can be constructed and a competition between two or more players can be conducted. This allows students to practice their math skills in a fun, non-threatening, and exciting environment. Additionally, the digits displayed on the dice can be color-coded so that the color of the digits on the dice matches the corresponding digits on the math matrix. For example, each digit with a value of “5” might be colored red and the corresponding single digit with a value of “5” on each of the two dice would likewise be colored red.

Additionally, all of the number relationships can be explored and explained by creating various game-related activities associated with the board game and the dice. Additionally, it is possible to employ one or more 100-sided die in conjunction with the board game, where each of the two-digit numbers from 00-99 displayed on exactly one of the 100 sides. In a similar fashion as explained in conjunction with the 10-sided die, various activities can be used to explore and explain mathematical concepts and number relationships. As with the 10-sided dice, the 100-sided die may also employ color coordination.

Another preferred embodiment of the present invention comprises a casino-style game similar to Keno. In this embodiment, a power source can be coupled to a matrix as described in the previous embodiments of the present invention. The power source is configured to illuminate one or more of the two-digit numbers as the two-digit numbers are randomly selected. Additionally, various odds and payouts can be associated with various number combinations displayed on the math matrix. Bingo-style balls may be drawn to illuminate various two-digit numbers on a large math matrix displayed for the game. Alternatively, 10-sided dice or 100-sided dice may be used as described above. The dice may be rolled on a table as with roulette or some other similar process may be utilized to randomly select two-digit numbers. As the two-digit numbers are selected, the numbers can be selectively highlighted on an illuminated math matrix displayed for the game-playing observers to track. As the various combinations are displayed, payouts can be made for the pre-determined winning combinations.

The various patterns and colored numbers described herein may be utilized to generate one or more game displays that can be projected on a screen or that can be implemented as a game board display. As numbers are selected, the corresponding number representation can be illuminated on the display. Gamblers can bet on the sequences of numbers, combinations of sequences, specific patterns of numbers, etc. Those skilled in the art will recognize that a virtually unlimited number of games of chance may be constructed around the various preferred embodiments of the present invention.

In yet another alternative preferred embodiment of the present invention, math matrix 100 of FIG. 1 can be printed onto a surface suitable for use as a poster or wall hanging. In this fashion, math matrix 100 of FIG. 1 can be displayed in a home or classroom environment for purposes of exploring mathematical concepts and number relationships. By providing varied and interesting color combinations for the two-digit numbers displayed on the poster or wall hanging, significant visual interest can be stimulated.

From the foregoing description, it should be appreciated that apparatus and method of the present invention provides significant benefits that would be apparent to one skilled in the art. It is also important to note that although the present invention has been described herein in the context of computer gaming, the various preferred embodiments of the invention are not limited to the arena of computer gaming. Each of the various preferred embodiments of the present invention are equally applicable to other similar environments such as computer-based software for mathematics instruction and training and the like. Furthermore, while multiple embodiments have been presented in the foregoing description, it should be appreciated that a vast number of variations in the embodiments exist. For example, it is specifically anticipated that the math matrix of the present invention may be incorporated into a computer game, suitable for deployment on one or more computer systems as a tool for teaching mathematics or as a game for amusement.

Lastly, it should be appreciated that the embodiments described herein are exemplary embodiments only, and are not intended to limit the scope, applicability, or configuration of the invention in any way. Rather, the foregoing detailed description provides those skilled in the art with a convenient road map for implementing one or more preferred exemplary embodiments of the invention, it being understood that various changes may be made in the application of the preferred embodiments without departing from the spirit and scope of the invention as set forth in the appended claims.

1. A math matrix comprising:
a first row comprising 10 cells, each of said 10 cells containing one of a series of two-digit numbers ranging from 00 to 09;
a second row comprising 10 cells, each of said 10 cells containing one of a series of two-digit numbers ranging from 10 to 19;
a third row comprising 10 cells, each of said 10 cells containing one of a series of two-digit numbers ranging from 20 to 29,
a fourth row comprising 10 cells, each of said 10 cells containing one of a series of two-digit numbers ranging from 30 to 39;
a fifth row comprising 10 cells, each of said 10 cells containing one of a series of two-digit numbers ranging from 40 to 49;
a sixth row comprising 10 cells, each of said 10 cells containing one of a series of two-digit numbers ranging from 50 to 59;
a seventh row comprising 10 cells, each of said 10 cells containing one of a series of two-digit numbers ranging from 60 to 69;
an eighth row comprising 10 cells, each of said 10 cells containing one of a series of two-digit numbers ranging from 70 to 79;
a ninth row comprising 10 cells, each of said 10 cells containing one of a series of two-digit numbers ranging from 80 to 89; and
a tenth row comprising 10 cells, each of said 10 cells containing one of a series of two-digit numbers ranging from 90 to 99.

2. The math matrix of claim 1 wherein each digit of said two-digit numbers is identified by one of a plurality of colors, each like digit being associated with a like color from said plurality of colors.

3. The math matrix of claim 2 further comprising a poster, said math matrix being displayed on said poster.

4. The math matrix of claim 2 further comprising a game board, said math matrix being displayed on said game board.

5. The math matrix of claim 4 further comprising a pair of 10-sided dice, each side of said 10-sided dice displaying a single digit ranging from 0-9 with no two single digits being repeated.

6. The math matrix of claim 5 wherein each single digit on each of said pair of 10-sided dice is color-coded to correspond to each digit of said two digit numbers.

7. The math matrix of claim 4 further comprising at least one 100-sided die, each side of said 100-sided die displaying a two-digit number ranging from 00-99 with no two-digit numbers being repeated.

8. A method comprising the steps of: providing a math matrix, said math matrix comprising:
a first row comprising 10 cells, each of said 10 cells containing one of a series of two-digit numbers ranging from 00 to 09;
a second row comprising 10 cells, each of said 10 cells containing one of a series of two-digit numbers ranging from 10 to 19;
a third row comprising 10 cells, each of said 10 cells containing one of a series of two-digit numbers ranging from 20 to 29,
a fourth row comprising 10 cells, each of said 10 cells containing one of a series of two-digit numbers ranging from 30 to 39;
a fifth row comprising 10 cells, each of said 10 cells containing one of a series of two-digit numbers ranging from 40 to 49;
a sixth row comprising 10 cells, each of said 10 cells containing one of a series of two-digit numbers ranging from 50 to 59;
a seventh row comprising 10 cells, each of said 10 cells containing one of a series of two-digit numbers ranging from 60 to 69;
an eighth row comprising 10 cells, each of said 10 cells containing one of a series of two-digit numbers ranging from 70 to 79;
a ninth row comprising 10 cells, each of said 10 cells containing one of a series of two-digit numbers ranging from 80 to 89; and
a tenth row comprising 10 cells, each of said 10 cells containing one of a series of two-digit numbers ranging from 90 to 99;
identifying a first cell on said math matrix, said first cell containing a first two-digit number;
identifying a second cell on said math matrix, said second cell containing a second two-digit number;
using said second two-digit number to locate a third cell on said math matrix, said third cell containing a third two-digit number; and
using said first two-digit number and said second two-digit number and said third two-digit number to form a mathematically correct algebraic equation.

9. The method of claim 8 wherein said mathematically correct algebraic equation is an addition equation.

10. The method of claim 8 wherein said mathematically correct algebraic equation is a subtraction equation.

11. The method of claim 8 wherein said step of using said second two-digit number to locate a third cell on said math matrix, said third cell containing a third two-digit number comprises the steps of:
moving up the math matrix from the first cell by the number of cells represented by the first digit of said second two-digit number, thereby locating an intermediate cell on said math matrix; and
moving to the left of the intermediate cell on the math matrix by the number of cells represented by the second digit of said second two-digit number, thereby locating said third cell.

12. The method of claim 8 wherein said step of using said second two-digit number to locate a third cell on said math matrix, said third cell containing a third two-digit number comprises the steps of:
moving to the left of the first cell on the math matrix by the number of cells represented by the second digit of said second two-digit number, thereby locating an intermediate cell; and
moving up the math matrix from the intermediate cell by the number of cells represented by the first digit of said second two-digit number, thereby locating said third cell on said math matrix.

13. The method of claim 8 wherein said step of using said second two-digit number to locate a third cell on said math matrix, said third cell containing a third two-digit number comprises the steps of:
moving down the math matrix from the first cell by the number of cells represented by the first digit of said second two-digit number, thereby locating an intermediate cell on said math matrix; and
moving to the right of the intermediate cell on the math matrix by the number of cells represented by the second digit of said second two-digit number, thereby locating said third cell.

14. The method of claim 8 wherein said step of using said second two-digit number to locate a third cell on said math matrix, said third cell containing a third two-digit number comprises the steps of:
moving to the right on the math matrix by the number of cells represented by the second digit of said second two-digit number, thereby locating an intermediate cell; and
moving down the math matrix from the intermediate cell the number of cells represented by the first digit of said second two-digit number, thereby locating said third cell on said math matrix.

15. A gambling game comprising a matrix, said matrix comprising:
a first row comprising 10 cells, each of said 10 cells containing one of a series of two-digit numbers ranging from 00 to 09;
a second row comprising 10 cells, each of said 10 cells containing one of a series of two-digit numbers ranging from 10 to 19;
a third row comprising 10 cells, each of said 10 cells containing one of a series of two-digit numbers ranging from 20 to 29,
a fourth row comprising 10 cells, each of said 10 cells containing one of a series of two-digit numbers ranging from 30 to 39;
a fifth row comprising 10 cells, each of said 10 cells containing one of a series of two-digit numbers ranging from 40to 49;
a sixth row comprising 10 cells, each of said 10 cells containing one of a series of two-digit numbers ranging from 50 to 59;
a seventh row comprising 10 cells, each of said 10 cells containing one of a series of two-digit numbers ranging from 60 to 69;
an eighth row comprising 10 cells, each of said 10 cells containing one of a series of two-digit numbers ranging from 70 to 79;
a ninth row comprising 10 cells, each of said 10 cells containing one of a series of two-digit numbers ranging from 80 to 89; and
a tenth row comprising 10 cells, each of said 10 cells containing one of a series of two-digit numbers ranging from 90 to 99; and
a power source coupled to said matrix, said power source being configured to selectively illuminate one or more of said two-digit numbers.

16. The gambling game of claim 15 further comprising a series of odds associated with various combinations of said two-digit numbers.

17. The gambling game of claim 15 further comprising a series of payouts associated with various combinations of said two-digit numbers.

18. A computer system comprising:
at least one processor;
at least one memory coupled to said at least one processor; and
a math matrix application residing in said at least one memory, said math matrix application constructing a math matrix in said at least one memory, said math matrix comprising:
a first row comprising 10 cells, each of said 10 cells containing one of a series of two-digit numbers ranging from 00 to 09;
a second row comprising 10 cells, each of said 10 cells containing one of a series of two-digit numbers ranging from 10 to 19;
a third row comprising 10 cells, each of said 10 cells containing one of a series of two-digit numbers ranging from 20 to 29,
a fourth row comprising 10 cells, each of said 10 cells containing one of a series of two-digit numbers ranging from 30 to 39;
a fifth row comprising 10 cells, each of said 10 cells containing one of a series of two-digit numbers ranging from 40 to 49;
a sixth row comprising 10 cells, each of said 10 cells containing one of a series of two-digit numbers ranging from 50 to 59;
a seventh row comprising 10 cells, each of said 10 cells containing one of a series of two-digit numbers ranging from 60 to 69;
an eighth row comprising 10 cells, each of said 10 cells containing one of a series of two-digit numbers ranging from 70 to 79;
a ninth row comprising 10 cells, each of said 10 cells containing one of a series of two-digit numbers ranging from 80 to 89; and
a tenth row comprising 10 cells, each of said 10 cells containing one of a series of two-digit numbers ranging from 90 to 99.

19. The system of claim 18 further comprising:
a video display coupled to said at least one processor; and
a screen saver application residing in said at least one memory, said screen saver application displaying at least a portion of said math matrix on said video display.

20. The system of claim 18 further comprising:
a user input device coupled to said at least one processor; and
a user, said user interacting with said math matrix application via said user device.

21. The system of claim 18 further comprising a network coupled to said at least one processor.

22. The system of claim 21 further comprising a printer coupled to said network.
